(19) United States
(12) Patent Application Publication
(10) Pub. No.: US 2021/0133369 A1
(43) Pub. Date: May 6, 2021

(54) MACHINE LEARNING FOR MONITORING, MANAGING AND MAINTAINING EDGE DATA CENTERS

(71) Applicant: HEWLETT PACKARD ENTERPRISE DEVELOPMENT LP, Houston, TX (US)

(72) Inventors: Tahir Cader, Liberty Lake, WA (US); Mehmet Kivanc Ozonat, San Jose, CA (US)

(21) Appl. No.: 16/673,243

(22) Filed: Nov. 4, 2019

(51) Int. Cl. G06F 30/20

(52) U.S. Cl. CPC G06F 30/20; G06F 2111/10

(57) ABSTRACT

In exemplary aspects of managing, monitoring and maintaining computing systems and devices such as edge data centers (EDCs), probabilistic models such as dynamic Bayesian networks (DBNs) are generated. The DBNs can define individual and collective systems such as EDCs. The DBNs are built by generating or estimating the model structure and model parameters. The model can be deployed, for instance, to identify actual or potentially anomalous behavior within the individual or collective systems defined by the model. The model can also be deployed to predict anomalous behavior. Based on the results of the model, corrective measures can be taken to remedy the anomalies, and/or to optimize the impact therefrom.

### BACKGROUND

Edge data centers (EDCs) are complex computing systems that are deployed within a closer proximity to endpoint systems and devices, as compared to central data centers. EDCs can therefore serve those endpoint systems and devices much more efficiently. In light of their benefits, EDCs are therefore being increasingly deployed, leading to a massive number of EDCs that must be managed, maintained and monitored.

### BRIEF DESCRIPTION OF THE DRAWINGS

Certain examples are described in the following detailed description and in reference to the drawings, in which:

FIG. 1 is a diagram illustrating an example distributed computing architecture including data centers;

FIG. 2 is a diagram illustrating an example edge data center (EDC);

FIG. 3 is a diagram illustrating an example EDC cooling unit;

FIG. 4 is a diagram illustrating relationships and dependencies in an example distributed computing architecture;

FIG. 5 is a flow chart illustrating an example process for generating one or more models that can be deployed to perform functions that can be used to optimally manage EDCs;

FIG. 6 is an example dependency diagram graphically representing an EDC;

FIG. 7 is an example model structure of a Bayesian network corresponding to the dependency diagram of FIG. 6;

FIG. 8 is a flow chart illustrating an example process for estimating parameters of a model;

FIG. 9 is an example of a model structure of a Bayesian dynamic network corresponding to a distributed computing architecture;

FIG. 10 is a Markov chain representing iterations as multiple time steps of behavior; and

FIG. 11 is a flow chart illustrating a process for deploying a model and providing optimized management of EDCs therewith.

### DETAILED DESCRIPTION

The proliferation of Artificial Intelligence (AI) and Machine Learning (ML) is resulting in massive amounts of data being generated, which in turn is overwhelming data networks. The impending widespread deployment of, for example, autonomous vehicles further contributes to the problems for data networks. To alleviate the saturation of the data networks, edge data centers (EDCs) are being deployed.

EDCs can be as small as a single rack with integrated power, cooling, and monitoring and management infrastructure, or several racks with their associated support infrastructure. The EDCs, in many cases, are remote. Keeping these EDCs well maintained and running could require a massive labor force, which is expensive and burdensome on resources.

As described herein, in some embodiments, AI and ML based tools can be deployed for comprehensive monitoring, management, and predictive maintenance. For instance, these tools can cause workload to be shifted from failed or failing EDCs to functional or optimal EDCs. These failures can result from failed fans, compressors, condenser coils, power supplies, switches, refrigerant leaks, and others known to those of skill in the art. To reduce or eliminate these issues and/or their impact, remote monitoring and data analytics can be used.

Thus, as described herein, in some embodiments, EDCs can be monitored, maintained, and managed using predictive models such as dynamic Bayesian networks that allow for the identification of actual and potential anomalies and failures, and prediction of future anomalies or failures. Based on this information, corrective actions can be performed, for example, to prevent these anomalies or failures if they have not yet occurred, or remedy or minimize their impact.

The invention described in this disclosure addresses the problems described herein, and more. In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

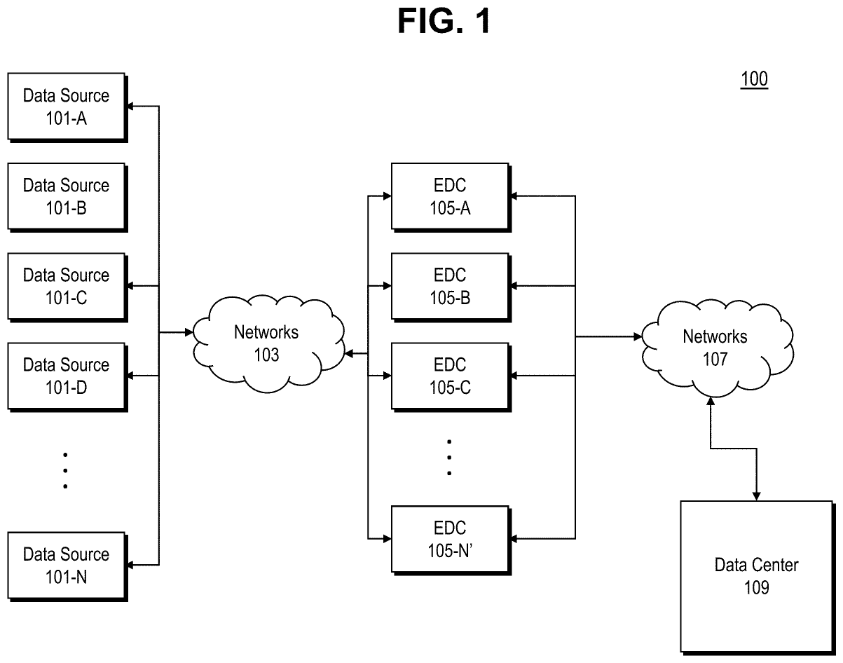

FIG. 1 is a diagram illustrating an example distributed computing architecture 100 that includes data centers. The architecture 100 includes edge devices 101-A, 101-B, 101-C, 101-D, . . . and 101-N (collectively “edge devices” and/or “101”); edge data centers (EDCs) 105-A, 105-B, 105-C, . . . , and 105-N′ (collectively “edge data centers,” “EDCs” and/or “105”); and a data center or central data center 109. As illustrated in FIG. 1, the edge devices 101 and EDCs 105 are communicatively coupled to or via networks 103; and the EDCs 105 and the data center 109 are communicatively coupled to or via networks 107.

The edge devices 101 can refer to and/or include any individual or group of physical objects (or “things”) configured to generate, transmit and/or receive data. In some embodiments, an edge device can refer to an individual object that produces, receives and/or transmits data, such as a sensor, device, or the like. Examples of sensors include sensors for measuring temperature, humidity, pressure, airflow, light, water, smoke, voltage, location, power, flow rates, doors, video, audio, speed, and many others known to those of skill in the art. Moreover, in some embodiments, an edge device can refer to an object that includes and/or is equipped or instrumented with multiple components capable of producing, receiving and/or transmitting data, such as sensors. For instance, an edge device can refer to a system, device, machine, person, building, infrastructure and the like, each of which contains a number of sensors or components that can produce, transmit and/or receive data. One such example, for purposes of illustration, is an automobile that includes a number of devices, sensors and the like that are capable of measuring or collecting data, and transmitting that data. For instance, an automobile can include radars, cameras, odometers, global positioning systems (GPS), and many others known to those of skill in the art. It should be understood that, in some embodiments, the edge devices 101 need not produce the data. That is, an edge device can be a computing device that can store, transmit and/or receive data (e.g., time series data, logs, etc.).

As described above, the edge devices 101 are equipped with communications capabilities that enable them to transmit and/or receive data. For instance, the edge devices 101 can be configured to communicate via wired or wireless networks—e.g., networks 103. The networks 103 can be or include multiple types of networks, including cellular networks, personal area networks (PAN), local area networks (LAN), wireless LANs (WLAN), campus area networks (CAN), metropolitan area networks (MAN), virtual private network (VPN), and others known to those of skill in the art. Moreover, the communications via the networks 103 can be performed using a number of different protocols such as ZigBee, Z-Wave, Bluetooth, BLE, 6LoWPAN, radio frequency identification (RFID), near field communication (NFC), cellular (e.g., 3G, 4G, 5G), Wi-Fi and others known to those of skill in the art.

The edge devices 101 are communicatively coupled with the EDCs 105. Although not illustrated in FIG. 1, it should be understood that all edge devices 101 need not be configured to communicate with all EDCs 105. For instance, in some embodiments, the edge device 101-A can be configured to communicate only with EDCs 105-2 and 105-3 of FIG. 1. Moreover, one or more of the EDCs 105 can be configured to communicate with one another. The EDCs 105 refer to a collection of systems, devices, sensors, tools, components and the like, each of which can itself include systems, devices, sensors, tools, components and the like. For purposes of simplicity, in some examples, some systems, devices, sensors, tools, components, and the like in a first level of a hierarchy of systems, devices, sensors, tools, components, and the like of an EDC can be referred to interchangeably as “systems,” and the systems, devices, sensors, tools, components, and the like in a second level of a the hierarchy can be referred to interchangeably as “sub-systems.”

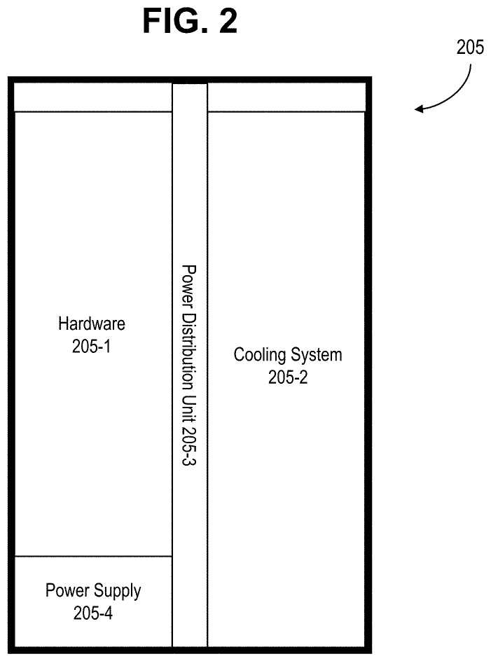

An example EDC is described in further detail below with reference to FIG. 2. Nonetheless, it should be understood that, in some embodiments, an EDC is smaller and includes fewer resources than a traditional or central data center (e.g., data center 109) located at the core. The size and complexity of an EDC can range from, for example, a single rack with an integrated power, cooling, and monitoring and management infrastructure, or several racks with associated support infrastructure. The EDCs 105 can be located or positioned at “the edge”—meaning closer or more proximate to the edge devices 101, as compared with the data center 109. In this way, the EDCs 105 can generally communicate (e.g., transmit or receive data) with the edge devices 101 faster and with minimal latency, as compared with communications between edge devices 101 and the data center 109.

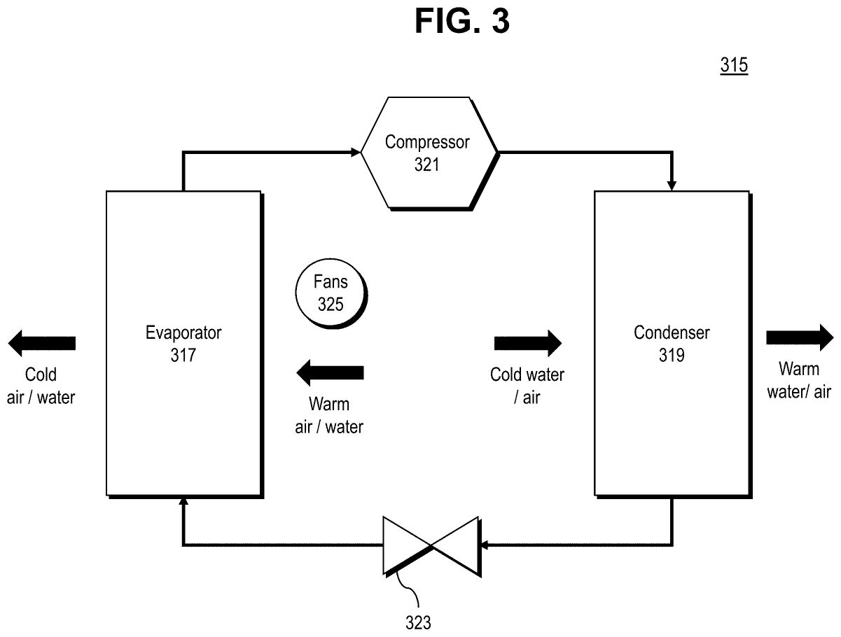

As discussed above, an EDC can include any number of systems (e.g., systems, devices, sensors, tools, components and the like) each of which can include or be made up of sub-systems. As described in further detail below—e.g., with reference to FIG. 2—in some embodiments, the systems and sub-systems can be equipped with sensors for measuring, sampling or collecting data, which can in turn be processed and/or transmitted to other computing devices (e.g., central data center). It should be understood that the systems, sub-systems, sensors and the like of an EDC can be provided in a single housing or chassis or in separate housings or chassis. FIG. 2 illustrates an example EDC 205. As illustrated, the EDC 205 includes hardware 205-1, cooling unit 205-2, power distribution unit (PDU) rack 205-3, and power supply (e.g., uninterruptible power supply (UPS)) 205-4. It should be understood that the EDC 205 can include any number of additional systems, sub-systems, sensors and the like (e.g., devices, components, parts, capabilities, and the like that are known to those of skill in the art) that are not illustrated in example FIG. 2. For instance, although not shown in FIG. 2, the EDC 205 can include rack access means, cables, cable access means, and security and monitoring devices such as cameras, alarms, sensors (e.g., temperature, humidity, pressure), smoke detectors and others. In FIG. 3, for instance, various sensors of an EDC are illustrated relative to a cooling system. Data measured and/or collected by the sensors can be transferred via wired and/or wireless means to the computing hardware of the EDC, where it can be further processed and/or transmitted to other computing devices (e.g., central data center).

The hardware 205-1 of the example EDC 205 includes, among other things, networking or input/output, memory, compute and/or storage elements or resources. In some embodiments, the hardware 205-1 can be referred to as a system, with each element (e.g., compute element, storage element, etc.) being referred to as a sub-system. The networking or input/output, memory, compute and/or storage elements or resources can be provided as part of one or more sub-systems (or component or device). For example, the hardware 205-1 can include servers such as compute or storage servers. In some embodiments, the hardware 205-1 can include a management system that includes, among other things, processing, memory and communication elements (e.g., processor, memory, interfaces), and can be configured to provide management of or for the EDC 205.

As known to those of skill in the art, each server can be equipped with one or more processors, memory and interfaces (e.g., network, I/O). In some embodiments; the processors can be or include one or more microprocessors, microcontrollers, application specific integrated circuits (ASICs), central processing units (CPUs), graphics processing units (GPUs), systems on a chip (SoCs), quantum processors, chemical processors or other processors, known to those of skill in the art, hardware state machines, hardware sequencers, digital signal processors (DSPs), field programmable gate array (FPGA) or other programmable logic device, gate, or transistor logic, or any combination thereof. In some embodiments; the memory can be volatile or non-volatile memory, and can include one or more devices such as read-only memory (ROM), Random Access Memory (RAM), electrically erasable programmable ROM (EEPROM)), flash memory, registers or any other form of storage medium known to those of skill in the art. In some embodiments, the hardware and/or servers can include network interface controllers or the like for communicating with the edge devices 101 through the networks 103 and the data center 109 through the networks 109. In some embodiments, the networking hardware can include network switches or the like.

In some embodiments, the hardware 205-1 can include memory for storing software (e.g., machine-readable instructions), for example, to perform functions on or for the EDC 205. For instance, the software can be configured to provide remote management, real-time monitoring and control of the EDC 205 and/or its systems, devices, components, etc.

The PDU 205-3 is a device configured to distribute electric power, for example, to racks of computers and networking equipment located within a data center. The power supply 205-4 is a device that can provide battery backup when the electrical power fails or drops to an unacceptable voltage level. In some embodiments, the PDU 205-3 can be configured remotely by other computing devices.

Still with reference to the EDC 205 of FIG. 2, the cooling unit 205-2 refers to one or more tools, devices, techniques, components, parts, and the like that are configured to attempt or ensure that the operating temperature of or within the EDC 205 is optimal. FIG. 3 illustrates an example cooling unit 315. The cooling unit 315 shown in FIG. 3 is a vapor-compression refrigeration system (VCRS) that can be used to cool or lower the temperature of an EDC or portions thereof (e.g., by removing heat from a space and transferring it elsewhere). It should be understood that other cooling units or techniques known to those of skill in the art can be used to cool EDCs and central data centers.

The cooling unit 315 can, in some embodiments, be referred to as a system that includes various sub-systems and sensors. For example, as shown in FIG. 3, the cooling unit 315 includes an evaporator 317, condenser 319, compressor 321, and expansion valve 323. In some embodiments, the cooling unit 315 can also include an oil separator, expansion valve regulator, solenoid valve, dryer, sensing bulb, and other sub-systems known to those of skill in the art. The cooling unit can circulate a liquid refrigerant to absorb and remove heat from a space that needs to be cooled, such as the interior of an EDC, and the absorbed heat is transferred elsewhere (e.g., outside of the EDC). A vapor-compression cycle to cod an EDO is now described in more detail with reference to FIG. 3. Refrigerant enters the compressor 321 as a saturated vapor and is compressed to a higher pressure, resulting in a higher temperature. In turn, the hot and compressed vapor is condensed in the condenser 319 using cooling water or cooling air flowing across a coil or tubes therein. At the condenser 319, the circulating refrigerant thereby rejects heat and transfers it elsewhere through either the water or aft. In turn; the condensed liquid refrigerant exiting the condenser 319 is routed through the expansion valve 323, where its pressure is reduced, causing a flash evaporation of part of the liquid refrigerant. The flash evaporation lowers the temperature of the liquid and vapor refrigerant mixture to a temperature lower than the temperature of the space to be cooled or refrigerated. The cold mixture of liquid and vapor refrigerant is routed through coils or tubes in the evaporator 317. A fan (or pump) 325 can circulate the warm air the in the EDO across the coil or tubes carrying the refrigerant liquid and vapor mixture. The warm air evaporates the liquid part of the mixture, and the circulating air is cooled, thereby lowering the temperature of the EDO to a more optimal temperature. Moreover, in the evaporator 317, the circulating refrigerant absorbs and removes heat, transferring it elsewhere through the water or air in the condenser.

Although not illustrated in FIG. 3, the cooling unit 315 and its subsystems can be equipped with sensors configured to measure or coiled data. For instance, the cooling unit 315 can include sensors configured to measure pressure (e.g., indicating a need for refrigerant recharge if the pressure is low); the compressor 321 can include sensors configured to measure current draw, voltage, speed, temperature, cycle frequency (e.g., whether the compressor is running too long or too frequently); the evaporator 317 can be configured to measure air temperature and pressure at inlet, air temperature and pressure at exhaust, refrigerant temperature and pressure at inlet, refrigerant temperature and pressure at exhaust, blower current, blower voltage, blower speed, blower temperature, air relative humidity at inlet and/or exhaust. In some embodiments, the cooling unit can include a solenoid valve, which can include sensors configured to measure position, current and voltage. Of course, it should be understood that the cooling unit 315 and its subsystems can include any number and type of sensors described herein. Data measured or collected by the sensors can be transmitted via wired and/or wireless means to the computing hardware of the EDC and, in turn, transferred to other systems or devices such as a central data center.

Returning to FIG. 1, as described above, the EDCs 105 are communicatively coupled to the data center 109 via the networks 107. The networks 107 can include any number or types of wired or wireless networks (e.g., LANs, WANs, cellular, MAN, etc.), using any number or types of protocols described above and/or known to those of skill in the art. Generally, central or main data centers such as the data center 109 are typically located further from edge devices than EDCs, and latency is therefore higher for communications therewith. Moreover, such data centers are typically larger than EDCs and can therefore be more complex and provide more functionality. For example, they can include more IT resources (e.g., racks, servers, etc.) and more cooling resources.

In some embodiments, the data center 109 can refer to a fixed or movable site or location that includes or houses systems, sub-systems, devices, components, mechanisms, tools, instruments, and the like, which can interchangeably be referred to as “systems” and/or “sub-systems,” for purposes of simplicity. For instance, such systems or sub-systems of the data center 109 can include computing hardware such as servers, monitors, hard drives, disk drives, memories, mass storage devices, processors, micro-controllers, high-speed video cards, semi-conductor devices, printed circuit boards (PCBs), power supplies and the like, as known to those of skill in the art. In some embodiments, all or portions of the computing hardware can be housed in any number or racks. The computing hardware of the data center 109 can be configured to execute a variety of operations, including computing, storage, switching, routing, cloud solutions, management and others. In some embodiments, the systems and/or sub-systems of the data center 109 can be configured to communicate among each other and with external systems or sub-systems via wired or wireless communications means.

Moreover, the systems and sub-systems of the data center 109 can include cooling distribution units (CDUs), cooling towers, power components (e.g., uninterruptible power supplies (UPSs)) that provide and/or control the power and cooling within the data center, temperature components, fluid control components, chillers, heat exchangers (“HXs” or “HEXs”), computer room air handlers (CRAHs), humidification and dehumidification systems, blowers, pumps, valves, generators, transformers, switchgear and the like, as known to those of skill in the art.

It should be understood that the distributed computing architecture 100 of FIG. 1 can include any number of types of data sources, networks and, EDCs, data centers and the like beyond those that are illustrated for purposes of illustration. Moreover, as discussed in further detail below, the data sources, EDCs and data centers can have different communication couplings among themselves and with one another. For instance, two of the data sources 101 can be communicatively coupled to different ones of the EDCs 105.

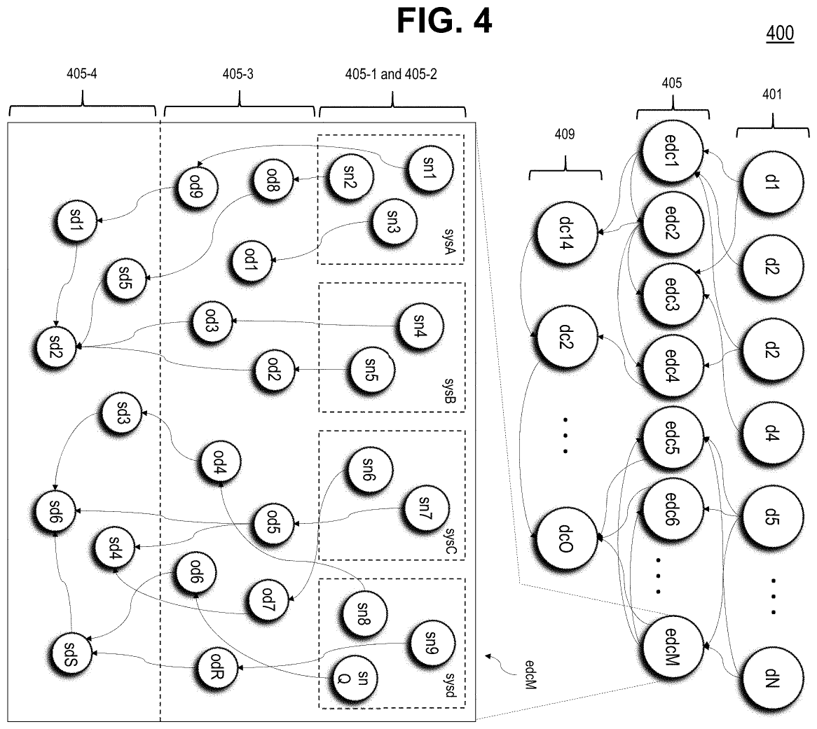

As described above, the number and complexity of EDCs can cause their management, maintenance and monitoring to be burdensome. In some embodiments, machine learning (ML) systems and techniques can be deployed to provide such management, maintenance and monitoring of EDCs. For purposes of simplicity, in some embodiments, the processes of monitoring, managing and maintaining EDCs can be referred to collectively as “managing” (or “management”). The ML systems and techniques for managing EDCs can be provided, in some embodiments, by a related central data center (e.g., data center 109 for the EDCs 105). Example aspects of such EDC management will now be described with reference to FIGS. 4 to 11.

Data sources, EDCs and data centers can be communicatively coupled and/or dependent on one another. One example of such dependencies can be an EDC that is configured to (i) collect data from a data source, and (2) receive and apply pre-trained ML models from a data center. FIG. 4 illustrates relationships and dependencies in an example distributed computing architecture 400. As described in further detail below, these relationships and dependencies can be used to provide ML-based management of the EDCs.

The computing architecture 400 can include any number of data sources, EDCs, data centers, and other systems, devices, components. In the illustrated example, the computing architecture 400 can include data sources d1, d2, . . . , dN (collectively “401”); EDCs edc1, edc2, . . . , edcM (collectively “405”); and data centers dc1, dc2, . . . , dcO (collectively “409”). At least a portion of the data centers 401, EDCs 405, and data centers 409, represented as nodes in FIG. 4 for illustration are related to one another, as represented by the arrows or edges therebetween shown in FIG. 4. In some embodiments, a relationship can refer to two nodes being communicatively coupled and/or having a dependency between them. As illustrated, in some embodiments, nodes of the same type can be related, such as edc1 and edc2. That is, edc2 can depend on and/or be communicatively coupled with edc1.

As described above, each data source, EDC and/or data center can include any number of systems, sub-systems, sensors, and the like. For example, as illustrated in the expanded illustration of edcM in FIG. 4, edcM can include systems or sub-systems known to those of skill in the art, including sysA, sysB, sysC, . . . , sysD (collectively “405-1”). Each of the systems or sub-systems 405-1, or the EDC edcM itself, can include any number of sensors configured to measure, collect, receive and/or transmit data, such as sensors sn1, sn2, . . . , snQ (collectively “405-2”) of any kind known to those of skill in the art. The data measured by the sensors 405-2 is referred to herein as “observation data” (e.g., it is “observed” by the sensors), and is illustrated in FIG. 4 as observation data nodes od1, od2, . . . , odR (collectively “405-3”). Moreover, data that represents a state of operation of a system or sub-system (or other device, component, aspect, feature, etc.) is referred to herein as “state data” or “states.” States can have one or more values. For example, a state can have possible values such as “normal” and “anomalous,” which respectively represent whether a sub-system, for example, is running the way it should (e.g., within an allowed range) or not (e.g., beyond the allowed range). As shown in FIG. 4, the EDC edcM can be associated or include states or state data sd1, sd2, . . . , sdS (collectively “405-4”). As also illustrated in FIG. 4, observations can be related to (e.g., share a dependency with) states and, states can be related to (e.g., share a dependency with) other states.

For example, the sysA of FIG. 4 can be a cooling system that includes sensors sn1, sn2 and sn3, among others not illustrated. For example, sn1 can be a sensor that measures air temperature at exhaust of the evaporator (observation data od9); sn2 can be a sensor that measure cycle frequency of the compressor (observation data od8); and sn3 can be a sensor that measures refrigerant level in the cooling system (observation data od1). In some embodiments, observation data od8 and od9 can be associated with state data sd1 and sd5, respectively. Each entry or record of state data 405-4 can represent state values (e.g., true, false or 0, 1) such as “compressor running inefficiently?” or “refrigerant level low?” Table 1 below illustrates examples of types of state and observation data. In FIG. 4, for instance, sd1 can represent a state data type “compressor running inefficiently.” As shown in FIG. 4, sd1 (compressor running inefficiently?) is related to and/or depends from the observation data od9 (cycle frequency of compressor). In some embodiments, this means that whether or not the compressor is running inefficiently (which can be considered a potential system anomaly), can depend on the measured cycle frequency of that compressor. In some embodiments, states can depend from other states, such as sd2 depending from sd1. For instance, the state of whether the “temperature of air delivered to IT is too high” (sd2) can depend on the state of whether the “compressor is running inefficiently” (sd1).

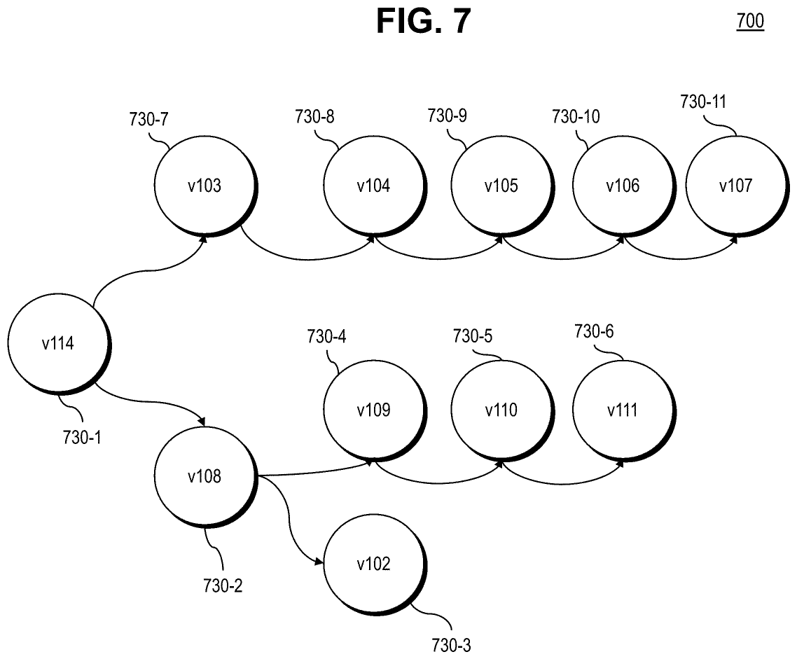

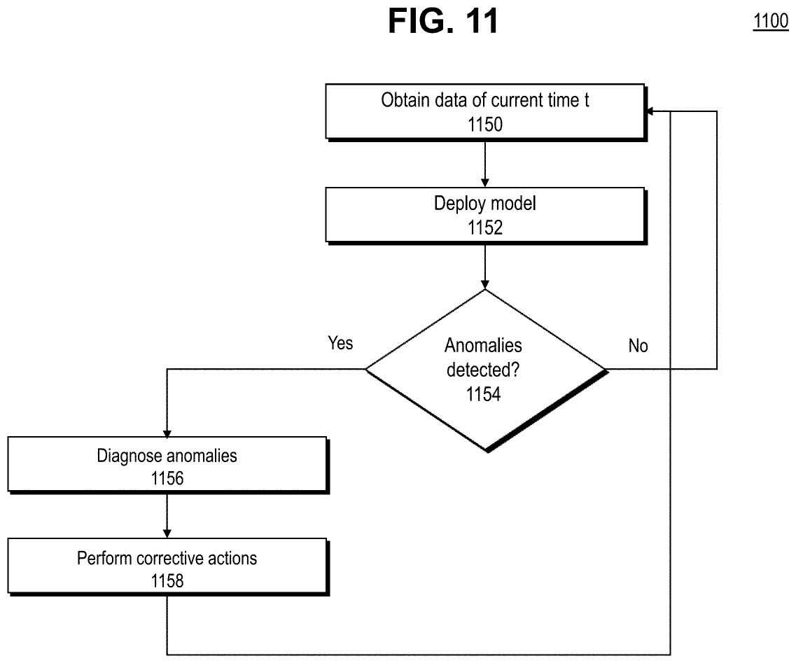

Using ML systems and techniques such as those described herein, dependencies such as those represented in FIG. 4 within individual data centers or EDCs (e.g., edcM) and/or generally throughout an entire architecture (e.g., 400) can be modeled (e.g., FIG. 7), and the models deployed to optimize management of EDCs (e.g., FIG. 11), as described in further detail below.

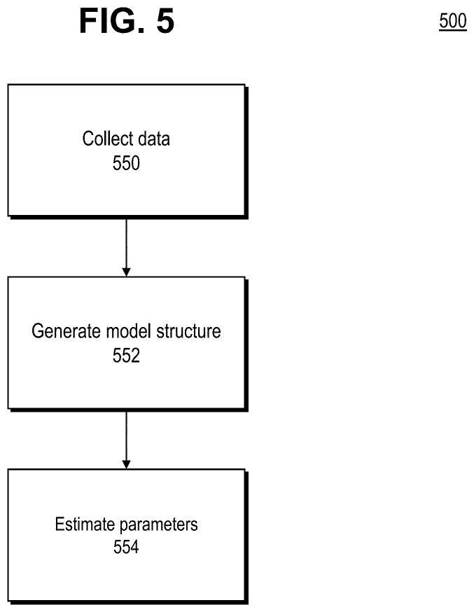

FIG. 5 is a flow chart illustrating an example process 500 for generating one or more models that can be deployed as described in further detail below, to perform functions that can be used to optimally manage EDCs. In some embodiments such one example described with reference to FIG. 5, the models are Bayesian networks (e.g., dynamic Bayesian networks) configured to relate variables (e.g., observation or state data) through a graph representation, namely a directed acyclic graph (DAG). Bayesian networks, can be used for a range of tasks or functions including prediction, anomaly detection, diagnostics, automated insights, reasoning, time series predictions, and other decisions known to those of skill in the art, which can in turn be used to manage EDCs. In some embodiments, the process of generating models can be performed by a management system, which can refer to one or more computing devices configured to provide management of EDCs. A management system can be part of and/or deployed at a central data center associated with and/or communicatively coupled to the EDCs.

At step 550, data is collected. The data that is collected can be any type of data that may be used, for example, for (1) structural learning; and (2) parameter learning or estimation, as described in further detail below with reference to steps 552 and 554. Examples of the data collected at step 550 include (i) graphical representations of data centers, EDCs or a distributed computing architecture; and (ii) historical data of variables associated with data centers, EDCs, and/or a distributed computing architecture, Graphical representations can be or refer to graphs, trees, hierarchical charts, tables, flow charts, and/or any diagram or that indicates relationships between variables. Variables can refer to any type of data, including states (e.g., discrete data) and observations (e.g., continuous variables). In some embodiments, variables and/or their graphical representations can correspond to systems, sub-systems, and the like. In some embodiments, such illustrations can be retrieved or obtained from other computing devices and/or memories.

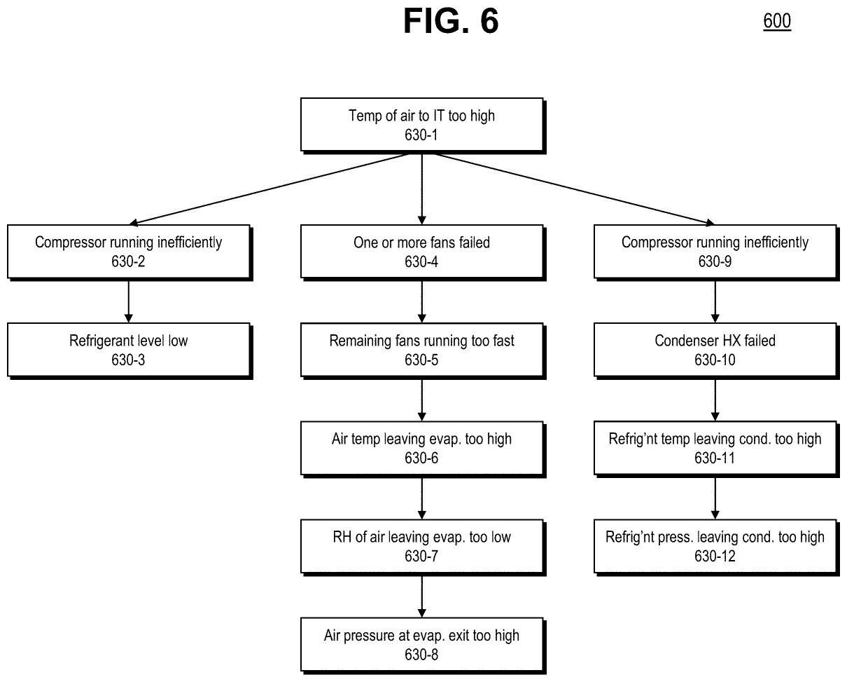

FIG. 6 illustrates an example graphical representation type of data that can be obtained at step 550 of FIG. 5. In particular, the graphical representation is a dependency diagram 600 showing relationships among a portion of variables of, associated with and/or defining an EDC. More specifically, the diagram 600 includes nodes 630-1 to 630-12 (collectively “630”), each of which represents a variable. In some embodiments; the example diagram 600 illustrates a variable in two different nodes, such as the variable of nodes 630-2 and 630-9. This can be caused by a variable having branches leading thereto or therefrom. The variables represented in FIG. 6 illustrate variables that are related to one another and can cause the temperature of the air delivered to IT to be too high (630-1). For example, whether or not the temperature of the air delivered to the IT is determined to be too high (630-1) can depend on whether the compressor is running inefficiently (630-2 and 630-9), whether one or more fans have failed (630-4). Moreover, whether the compressor is running inefficiently can depend on whether the refrigerant level is low (630-3). It should be understood that, for purposes of illustration, the example diagram of FIG. 600 represents state-type variables (e.g., discrete variables); however, such diagrams can also or additionally represent observation-type variables. Table 1 below is a listing of examples of variables associated with an EDO, including their type (e.g., state, observation). A graphical representation obtained at step 550 can include any of the variables of Table 1 and many others not listed therein.

TABLE 1

| ID | Name | Type |
|---|---|---|
| v100 | Air temp to IT too high | State |
| v101 | Compressor run inefficiently | State |
| v102 | Refrigerant level low | State |
| v103 | One or more fans failed | State |
| v104 | Operational fans running too fast | State |
| v105 | Air temp leaving the evaporator too high | State |
| v106 | Relative humidity of air leaving evaporator too low | State |
| v107 | Air pressure at evaporator exit too high | State |
| v108 | Compressor running inefficiently | State |
| v109 | Condenser heat exchanger (HX) failed | State |
| v110 | Refrigerant temp leaving condenser too high | State |
| v111 | Refrigerant pressure leaving condenser too high | State |
| v112 | Air temp at inlet | Observation |
| v113 | Air pressure at inlet | Observation |
| v114 | Air temp at exhaust | Observation |
| v115 | Air pressure at exhaust | Observation |
| v116 | Refrigerant temp at inlet | Observation |
| v117 | Refrigerant pressure at inlet | Observation |
| v118 | Refrigerant temp at exhaust | Observation |
| v119 | Refrigerant pressure at exhaust | Observation |
| v120 | Blower current | Observation |
| v121 | Blower voltage | Observation |
| v122 | Blower speed | Observation |
| v123 | Blower temperature | Observation |
| v124 | Air relative humidity at inlet | Observation |
| v125 | Air relative humidity at exhaust | Observation |
| v126 | Compressor current draw | Observation |
| v127 | Compressor voltage | Observation |
| v128 | Compressor temperature | Observation |
| v129 | Solenoid valve position | Observation |
| vn | Solenoid valve voltage | Observation |

In some embodiments, a graphical representation collected at step 550 can be a system architecture diagram showing relationships and/or dependencies between, for example, its data sources, EDCs, data centers, and the like (e.g., analogous to FIG. 1 and/or FIG. 4).

Moreover, at step 550, historical data can be obtained from a memory or a computing device, for instance. The historical data can be or include data collected over a period of time and that is relevant to the data sources, EDCs, data centers or otherwise of a distributed computing architecture. The historical data can include records of data of any type, including observation data and/or state data, among others. Table 2 below is a listing of an example dataset of historical data associated with an EDC.

TABLE 2

| | Variables | | | | | | | | | | |
|---|---|---|---|---|---|---|---|---|---|---|---|
| Index | v100 | v101 | v102 | v103 | . . . | v110 | v111 | . . . | v117 | v118 | v119 |
| 1 | 0 | 1 | 0 | 1 | . . . | 1 | 1 | . . . | 50 | 67 | 120 |
| 2 | 0 | 1 | 0 | 1 | . . . | 0 | 0 | . . . | 55 | 66 | 80 |
| 3 | 1 | 0 | 0 | 0 | . . . | 0 | 0 | . . . | 75 | 78 | 90 |
| 4 | 1 | 0 | 0 | 1 | . . . | 1 | 1 | . . . | 72 | 82 | 111 |
| 5 | 1 | 1 | 1 | 0 | . . . | 1 | 1 | . . . | 72 | 77 | 102 |
| 6 | 1 | 1 | 1 | 1 | . . . | 1 | 1 | . . . | 110 | 99 | 82 |
| . . . | . . . | . . . | . . . | . . . | . . . | . . . | . . . | . . . | . . . | . . . | . . . |
| 20 | 1 | 0 | 0 | 0 | . . . | 0 | 0 | . . . | 85 | 88 | 72 |
| 21 | 0 | 0 | 0 | 0 | . . . | 0 | 0 | . . . | 120 | 85 | 72 |
| 22 | 0 | 1 | 0 | 0 | . . . | 0 | 0 | . . . | 80 | 75 | 110 |
| 23 | 0 | 1 | 0 | 1 | . . . | 1 | 1 | . . . | 90 | 66 | 82 |
| 24 | 0 | 0 | 0 | 0 | . . . | 1 | 1 | . . . | 92 | 89 | 77 |
| 25 | 1 | 0 | 1 | 0 | . . . | 1 | 1 | . . . | 94 | 92 | 0 |
| . . . | . . . | . . . | . . . | . . . | . . . | . . . | . . . | . . . | . . . | . . . | . . . |
| 70 | 1 | 1 | 0 | 0 | . . . | 0 | 1 | . . . | 95 | 101 | 1 |
| 71 | 1 | 0 | 0 | 0 | . . . | 0 | 0 | . . . | 111 | 61 | 55 |
| 72 | 1 | 0 | 1 | 0 | . . . | 1 | 0 | . . . | 102 | 77 | 75 |
| 73 | 0 | 1 | 1 | 1 | . . . | 1 | 1 | . . . | 82 | 88 | 72 |
| n’ | 0 | 1 | 1 | 0 | . . . | 0 | 0 | . . . | 99 | 71 | 72 |

The historical data shown in Table 2 includes n′ number of records, which as used herein refers to an associated set (e.g., row) of the historical data. For example, in some embodiments, a set of data can be associated by time—meaning that the values correspond to measurements of a same given time period. In some embodiments, the variables shown in Table 2 correspond to the variables shown in Table 1.

Table 3 below is a listing of an example dataset of historical data associated with multiple EDCs:

TABLE 3

| | | Variables | | | | | | | | | |
|---|---|---|---|---|---|---|---|---|---|---|---|
| Index | Record ID | v100 | v101 | v102 | v103 | . . . | v110 | v111 | . . . | v117 | v118 |
| 1 | edcA_001 | 0 | 1 | 0 | 1 | . . . | 1 | 1 | . . . | 95 | 99 |
| 2 | edcC_025 | 0 | 1 | 0 | 1 | . . . | 0 | 0 | . . . | 111 | 71 |
| 3 | edcB_003 | 1 | 0 | 0 | 0 | . . . | 0 | 0 | . . . | 102 | 77 |
| 4 | edcD_010 | 1 | 0 | 0 | 1 | . . . | 1 | 1 | . . . | 82 | 88 |
| 5 | edcA_010 | 1 | 1 | 1 | 0 | . . . | 1 | 1 | . . . | 99 | 82 |
| 6 | edcA_011 | 1 | 1 | 1 | 1 | . . . | 1 | 1 | . . . | 92 | 72 |
| . . . | | . . . | . . . | . . . | . . . | . . . | . . . | . . . | . . . | . . . | . . . |
| 50 | edcB_120 | 1 | 0 | 0 | 0 | . . . | 0 | 0 | . . . | 50 | 67 |
| 51 | edcA_114 | 0 | 0 | 0 | 0 | . . . | 0 | 0 | . . . | 55 | 66 |
| 52 | edcD_055 | 0 | 1 | 0 | 0 | . . . | 0 | 0 | . . . | 75 | 78 |
| 53 | edcC_111 | 0 | 1 | 0 | 1 | . . . | 1 | 1 | . . . | 72 | 82 |
| 54 | edcA_120 | 0 | 0 | 0 | 0 | . . . | 1 | 1 | . . . | 72 | 67 |
| 55 | edcB_111 | 1 | 0 | 1 | 0 | . . . | 1 | 1 | . . . | 110 | 99 |
| . . . | | . . . | . . . | . . . | . . . | . . . | . . . | . . . | . . . | . . . | . . . |
| 110 | edcD_330 | 1 | 1 | 0 | 0 | . . . | 0 | 1 | . . . | 55 | 71 |
| 111 | edcA_423 | 1 | 0 | 0 | 0 | . . . | 0 | 0 | . . . | 75 | 81 |
| 112 | edcC_400 | 1 | 0 | 1 | 0 | . . . | 1 | 0 | . . . | 72 | 88 |
| 113 | edcD_420 | 0 | 1 | 1 | 1 | . . . | 1 | 1 | . . . | 111 | 72 |
| n” | edcB_242 | 0 | 1 | 1 | 0 | . . . | 0 | 0 | . . . | 102 | 70 |

The historical data of Table 3 includes n″ number of records or sets. The EDC with which a row or set of the historical data of Table 3 is associated can be identified using the Record_ID, which for purposes of illustration includes an identifier of the EDC with which that data is associated. For example, in some embodiments, a set of data can be associated by time—meaning that the values correspond to measurements of a same given time period. For example, the data of the row with index 3 is associated with one EDC (edcB), while the data of the row with index 4 is associated with another EDC (edcA). In some embodiments, the variables shown in Table 3 can correspond to the variables shown in Tables 1 and/or 2.

As described in further detail below, the graphical and/or historical data that is obtained at step 550 can be used in turn to build the structure of the model (e.g., Bayesian network) and/or estimate the parameters of the model.

At step 552, a model structure is generated, forming a probabilistic framework that represents a distributed computing architecture as well as each individual data source, EDC and/or data center. Of course, in some embodiments, one or more model structures can be generated. The model structure can be or refer to a graph (e.g., directed acyclic graph (DAG)), including its nodes (e.g., which represent variables) and edges (e.g., representing relationships or dependencies among the variables). As mentioned, in some embodiments, the nodes can represent variables of any kind (e.g., states, observations, latent variables, unknown parameters, hypotheses, and the like.

In some embodiments, a model structure can be generated or learned from graphical representations and historical data associated with an entire distributed architecture and individual data centers, data sources, EDCs, and the like. Building the model structure can be performed by employing, for example, expert knowledge leveraged through computing devices. That is, the graphical representations and historical data, which can illustrate relationships among variables, can be used at step 552 to generate the model structure. On the other hand, in some embodiments, structural learning can be performed using ML techniques known to those of skill in the art, including constraint-based algorithms and/or score-based algorithms.

FIG. 7 is a graphical representation of a Bayesian network 700. In some embodiments, the Bayesian network 700 is a visualization of a learned or generated model structure. As described above with reference to example step 552 of FIG. 5, the model structure of the Bayesian network 700 can be learned or generated based on obtained or retrieved data, such as a graphical representation and/or historical data. For example, the Bayesian network 700 can correspond to and be generated based at least in part on the dependency diagram 600 of FIG. 6. It should be understood that the model structure generated at step 552 can be much larger and more complex than network 700—e.g., by representing variables and relationships between data centers, data sources and EDCs of distributed architecture as well as variables and relationships of or within each one of the data centers, data sources and EDCs.

The Bayesian network 700 includes nodes 730-1 to 730-11 (collectively “730”). Each of the nodes 730 represents a variable corresponding to the variable identifiers (IDs) illustrated therein. In some embodiments, the variable IDs shown in FIG. 7 correspond to the variable IDs of Table 1 above. For instance, the node 730-1 represents a variable with variable ID v114. As shown in FIG. 114, v114 is the ID for variable “Air temp to IT too high.” The edges or links between two nodes of the nodes 730 indicate that one node directly influences or depends from or upon the other. In some embodiments, when an edge or link does not exist between two nodes, this does not mean that they are necessarily completely independent, as they may be connected via other nodes. Of course, it should be understood that the Bayesian network 700 merely represents examples of variables—that is, the number and types of variables that are associated with the EDC corresponding to the network 700 can be much larger than the partial, illustrative set of FIG. 7.

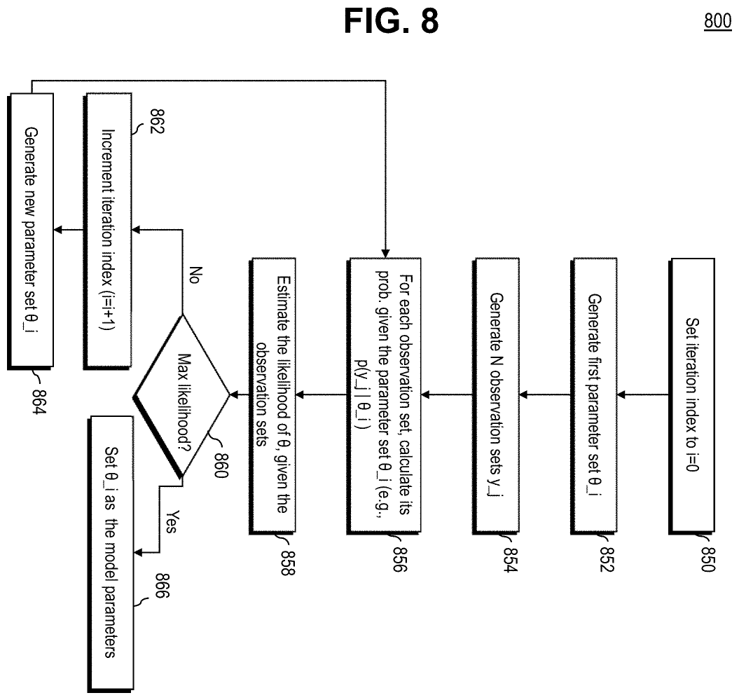

A fully defined and deployable Bayesian network model includes the probability distribution of every node therein. Yet, because some distributions (e.g., conditional distributions) include parameters that are unknown (e.g., the probability distribution for a node conditional upon that node's parents), the value of those parameters is obtained. At step 554 of FIG. 5, parameters of the model or probabilistic framework generated at step 552 are estimated. The model parameters define the blueprint of the model. Parameter estimation can be performed using techniques known to those of skill in the art such as Bayesian parameter estimation and/or maximum likelihood estimation (MLE). Methods such as MLE are configured to calculate or estimate the values of unknown parameters of probability distributions of a model that maximize a likelihood function—that is, that the parameter values maximize the likelihood that the process described by the model produced the data actually observed. An example of the parameter estimation of step 554 is described in further detail below with reference to FIG. 8.

FIG. 8 is a flow chart illustrating an example process 800 for estimating parameters of a model and/or probabilistic framework of a Bayesian network that relates, for instance, multiple EDCs, data centers and/or data sources. The process 800 can be used to estimate parameters of a model or framework of an individual data center or EDC, for example, or to estimate parameters of a model or framework of an architecture of multiple data centers and EDCs. As used herein, ‘θ’ or ‘Θ’ represent parameter sets, with Θ_model being the estimated parameter set of the model parameters that best matches or explains a dataset Y. In some embodiments Monte Carlo Markov Chains (MCMC) can be used for the parameter estimation. At step 850, an iteration index i is initialized to 0 (i=0). In turn, at step 852, a first parameter set θ_i is generated, in accordance with the Bayesian network. In some embodiments, the first parameter set θ_i includes guessed values, which in turn and throughout the iteration converge to an optimal model parameter set Θ_model.

At step 854, N number of observation sets y are generated from among the dataset Y. The dataset Y can be historical data corresponding to, for example, a single EDC (e.g., Table 2) or to an architecture or group of related EDCs (e.g., Table 3). An observation set refers to one subset or group of values for the variables in the dataset. For example, in Tables 2 and 3, an observation set y can refer to a single row of data (e.g., values) for the variables (e.g., variables v100 to v119), For purposes of illustration, in one example, observation sets y from can refer to the data in indices 1 (corresponding to a single EDC) and 50 (corresponding to edcA_010 from among many EDCs) of Tables 2 and 3, respectively:

| 0 | 1 | 0 | 1 | . . . | 0 | 0 | . . . | 55 | 66 | 80 | |
|---|---|---|---|---|---|---|---|---|---|---|---|
| edcD_420 | | 1 | 0 | 0 | 0 | . . . | 0 | 0 | . . . | 50 | 67 |

It should be understood that the number of observation sets N that are generated can refer to all or a portion of the subsets or groupings of data (e.g., n′ in Table 2, n″ in Table 3) in the datasets.

In turn, at step 856, a probability is calculated for each observation set generated at step 854. That is, starting with j=1 through j=N, and incrementing at each iteration, the probability of the observation set y_j given the parameter set θ_i is calculated; (e.g., p(y_j|θ_i). At step 858, the likelihood (e.g., log likelihood) of the parameter set θ_i given all of the observations sets y_1 . . . N is calculated (e.g., |(θ_i; y_1−N)). As known to those of skill in the art, the likelihood calculated at step 858 can based on the probabilities of each observation set calculated at step 856—e.g., the sum of all of the probabilities estimated at step 856.

At step 860, a determination is made as to whether the likelihood estimated at step 858 is the maximum or optimal likelihood—indicating that the selected or generated θ_i includes the parameter values that are most likely responsible for generating or most likely explain the observed data (e.g., observation sets y_1 . . . N). If it is determined at step 860 that the likelihood calculated at step 858 is optimal or maximum, in turn at step 866, the parameter set θ_i is deemed to be and or assigned as the model parameter set Θ_model (e.g., Θ_model=θ_i).

On the other hand, if the likelihood calculated at step 858 is not deemed to be the maximum or optimal likelihood then, in turn, at step 862 the iteration index i is incremented (i=i+1), and a new parameter set θ_i is generated at step 864. The newly generated parameter set θ_i is a new proposed set of parameter values that are based on the previous parameter set (e.g., θ_i−1), For example, the previous parameter set can be used as the mean of a multi-variate Gaussian with a pre-defined covariance matrix. In this way, the new parameter set causes the likelihood (e.g., log likelihood of step 858) to converge to its maximum value.

It should be understood that, in some embodiments, other machine learning (ML) techniques known to those of skill in the art, including deep learning and neural networks can also or alternatively be used to build and deploy the models described herein.

In some embodiments, the models described herein, such as the model that is generated using the process 500 of FIG. 5, can be a dynamic Bayesian network (DBN). As known to those of skill in the art, a DBN can relate variables to each other over adjacent or contiguous time periods (e.g., t−2, t−1, t, t+1, t+2, etc.). To generate a DBN, the variables of the historical data obtained at step 550 are associated with time. Table 4 below is a listing of example variables of multiple EDCs associated with time periods t−5 to t−1.

TABLE 4

| Index | Record ID | Time | v101 | v102 | v103 | . . . | v110 | v111 | . . . | v117 | v118 |
|---|---|---|---|---|---|---|---|---|---|---|---|
| 1 | edcA_001 | t-5 | 1 | 0 | 1 | . . . | 1 | 1 | . . . | 95 | 99 |
| 2 | edcC_025 | t-5 | 1 | 0 | 1 | . . . | 0 | 0 | . . . | 111 | 71 |
| 3 | edcB_003 | t-5 | 0 | 0 | 0 | . . . | 0 | 0 | . . . | 102 | 77 |
| 4 | edcD_010 | t-4 | 0 | 0 | 1 | . . . | 1 | 1 | . . . | 82 | 88 |
| 5 | edcA_010 | t-4 | 1 | 1 | 0 | . . . | 1 | 1 | . . . | 99 | 82 |
| 6 | edcA_011 | t-4 | 1 | 1 | 1 | . . . | 1 | 1 | . . . | 92 | 72 |
| . . . | | . . . | . . . | . . . | . . . | . . . | . . . | . . . | . . . | . . . | . . . |
| 50 | edcB_120 | t-3 | 0 | 0 | 0 | . . . | 0 | 0 | . . . | 50 | 67 |
| 51 | edcA_114 | t-3 | 0 | 0 | 0 | . . . | 0 | 0 | . . . | 55 | 66 |
| 52 | edcD_055 | t-2 | 1 | 0 | 0 | . . . | 0 | 0 | . . . | 75 | 78 |
| 53 | edcC_111 | t-2 | 1 | 0 | 1 | . . . | 1 | 1 | . . . | 72 | 82 |
| 54 | edcA_120 | t-2 | 0 | 0 | 0 | . . . | 1 | 1 | . . . | 72 | 67 |
| 55 | edcB_111 | t-4 | 0 | 1 | 0 | . . . | 1 | 1 | . . . | 110 | 99 |
| . . . | | . . . | . . . | . . . | . . . | . . . | . . . | . . . | . . . | . . . | . . . |
| 110 | edcD_330 | t-1 | 1 | 0 | 0 | . . . | 0 | 1 | . . . | 55 | 71 |
| 111 | edcA_423 | t-1 | 0 | 0 | 0 | . . . | 0 | 0 | . . . | 75 | 81 |
| 112 | edcC_400 | t-1 | 0 | 1 | 0 | . . . | 1 | 0 | . . . | 72 | 88 |
| 113 | edcD_420 | t-1 | 1 | 1 | 1 | . . . | 1 | 1 | . . . | 111 | 72 |
| n” | edcB_242 | t-1 | 1 | 1 | 0 | . . . | 0 | 0 | . . . | 102 | 70 |

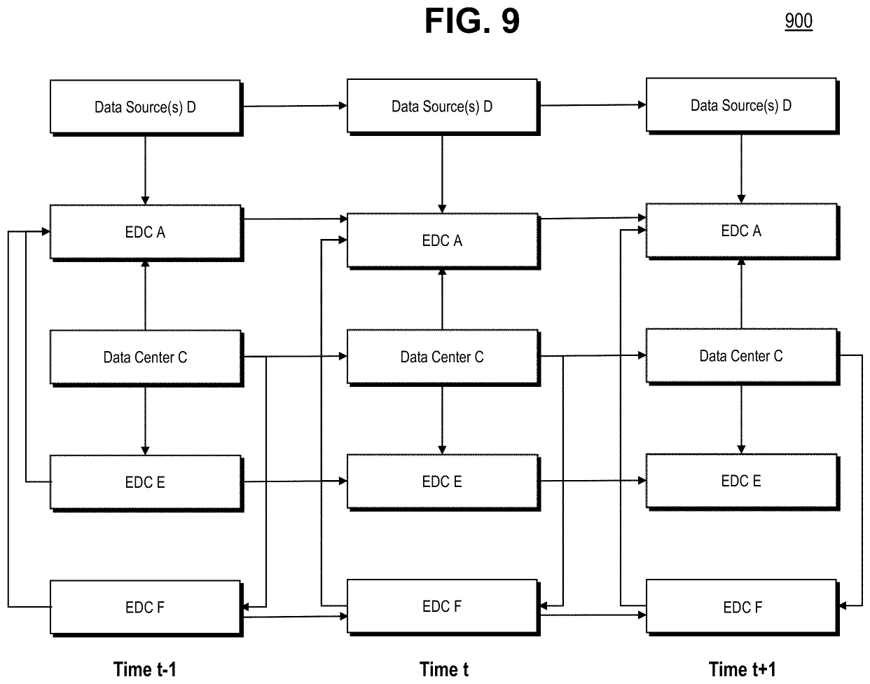

For example, in table 4, the data at index 1 includes values of variables measured and/or collected at time period t−5. As described above with reference to step 552 of FIG. 5, a model structure can be constructed, including based on the historical data and/or graphical representation data obtained at step 550. FIG. 9 illustrates an example of a model structure generated at step 552, namely a dynamic Bayesian network 900 showing high level dependencies among data sources, data centers and EDCs. Of course, it should be understood that the nodes and dependencies shown in FIG. 9 are merely a generalized view for purposes of illustration—as the nodes therein include or represent any number of nodes representing variables, and dependencies among variables within each and among all data sources, data centers or EDCs. Moreover, the dynamic Bayesian network 900 represents and/or illustrates the dependencies across example time periods t−1, t and t+1.

The parameters of the dynamic Bayesian network 900 can also be estimated as described above with reference to step 554 and the process 800 of FIG. 8. That is, an iteration index i is set to 0 (i=0). The observation data can include data identifying the EDC, system, sub-system, sensor or the like with which the data is associated (e.g., the EDC that produced the data). In contrast to the process 800 of FIG. 8, the observation sets y_j to y_N that are generated include time data that is associated therewith:

| | | | | | | | | | | |
|---|---|---|---|---|---|---|---|---|---|---|
| edcD_420 | t-1 | 1 | 1 | 1 | . . . | 1 | 1 | . . . | 111 | 72 |

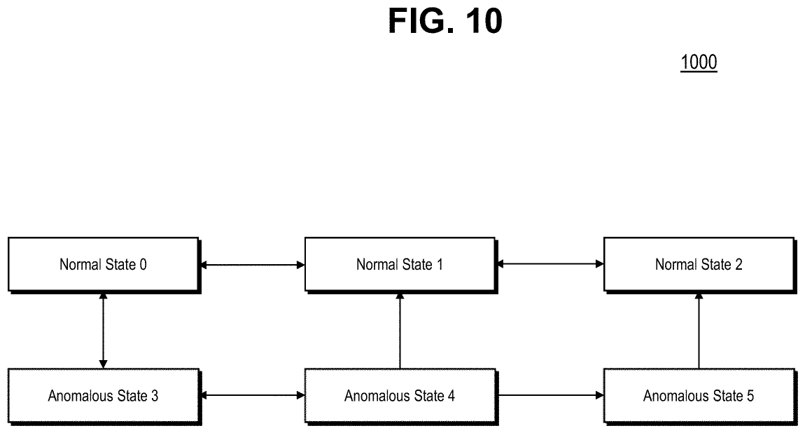

In some embodiments, a Markov chain can be used to represent the dependencies within each iteration of the MCMC. To do so, the dependencies are constructed or generated such that each iteration consists or represents multiple time steps of behavior (e.g. normal state, anomalous state). FIG. 10 illustrates an example Markov chain 1000 representing the dependencies across data centers, EDCs, data sources and the like (e.g., their variables). The parameters of the Markov chain can be estimated as described above with reference to step 554 of FIG. 5 and the process 800 of FIG. 8. In contrast to the process 800 of FIG. 8, the observation sets y represent observation data obtained or collected over a period of time (e.g., multiple, contiguous time steps or points in time; e.g., t−5 to t−1).

Once a model has been generated as described above with reference to example process 500, the model can be deployed to perform various functions that can be used, for example, to optimize management of EDCs. It should be understood that, although not described herein, building a model can include alternative or additional steps such as pre-processing; validation, testing and others known to those of skill in the art. FIG. 11 below is a flow chart illustrating an example process 1100 for deploying the model and providing optimized management of EDCs.

In some embodiments, the process 1100 can be executed or performed by one or more management computing systems or devices. For example, these management computing systems or devices can be part of a central data center or the like with which multiple EDCs being managed are associated. Moreover, it should be understood that, for purposes of illustration only, (i) the process 1100 is described with reference to a “current” time period t, relative to a real-time or substantially real-time system and process; (ii) the model that is deployed is a dynamic Bayesian network that models relationships and dependencies of systems (e.g., EDCs) collectively and individually, and across time; and (iii) prior to time t, data (e.g., historical data) can be collected (e.g., using sensors of the EDCs), transmitted and/or stored (e.g., in a memory of the management system).

At time t, in step 1150 of the process 1100, data (hereinafter referred to as data_t) is obtained. The obtained data_t can be collected; aggregated and/or transmitted by the EDCs to the management system. That data_t can therefore include data collected and/or corresponding to multiple systems (e.g., EDCs). The data_t, which is labeled or otherwise associated with the time t (e.g., as shown in Table 4 above); can be of any type, including observed data and/or state data. The data_t can function as potential evidence for predicting or identifying anomalies. In some embodiments, “anomalies” can be used interchangeably for purposes of simplicity to refer failures; errors, discrepancies, problems, issues, and the like that indicate some level of abnormal behavior or function.

At step 1152, the model is run or deployed using input data that includes at least some or all of the data_t. As described above, the model can be a dynamic Bayesian network, such as that illustrated in FIG. 9, which models relationships among nodes within individual systems (e.g. EDCs) and across an entire architecture, and over a period of time such as time t-n to time t. Accordingly, in addition or alternatively to the data that is input into the nodes being from the data_t, the input data can also be data from prior time instances such as time t−1 (e.g., model outputs of t−1). For example, the data input into a node corresponding to EDC A in FIG. 9 can include (i) data collected at time t (e.g., data_t); (ii) data of, corresponding to or output from one or more nodes of the EDC A associated with time t; (iii) data of, corresponding to or output from one or more nodes of the EDC F associated with time t; and (iv) model outputs of one or more nodes of the EDC A and associated with time t−1 (e.g., model_outputs_t−1).

Moreover, in some embodiments, the data_t can include observed or measured data (e.g., observation data from sensors) or data that is otherwise collected or calculated. For instance, as shown in FIG. 4, the measurements of sensors sn1 to snQ generate observation data od1 to odR—that is, the values that are measured by the sensors are mapped to specific variables that are of observation data type—and this observation data can be part of the data_t used for input into the model. It should be understood that observation data can be obtained or collected through means other than sensors that traditionally measure data. For example, the observation data can be received over a network or interface from a computing system or device, and calculated or processed (e.g., by a processor of an EDC, data center, and/or management system). Such data can be a function of other data.

Still with reference to step 1152 of FIG. 11, once the data (e.g., data_t, data_t−1, etc., as appropriate) has been input into the model, the model is deployed. Deploying the model includes running the model using the input data. As known to those of skill in the art, deploying the model causes the input data to be processed by its functions, thereby generating and/or outputting a joint probability distribution and/or the conditional probability for each node in the graph. The outputs or results of the model can be referred to herein interchangeably as “model outputs.” Thus, for each node, the model outputs include the probability of each possible value for that node (e.g., true, false) given the input data (e.g., data_t, etc.). In some embodiments, at step 1152, the output probabilities of the model can be further processed in a post-processing state to arrive at the data most optimal to determine the existence of potential or actual anomalies at step 1154.

It should be understood that at least some of the nodes represent anomalies (referred to as “anomalous nodes” or “anomalous nodes”) or other states that may not be known or measureable prior to the deployment of the model. Nonetheless, the model can generate model outputs for those nodes—e.g., anomalous nodes. For instance, the input data that is fed into the model may not include a value for the state of a node at time t, such as whether one or more fans have failed in an EDC. Still, the model can determine the probabilities for the potential values true and false of the variable “One or more fans have failed,” represented by an anomaly node in the graph.

Accordingly, in turn, at step 1154, the model outputs obtained at step 1152 are used to determine whether, based on existing data, anomalies or potential anomalies have occurred. Anomalies refer to actual anomalous behavior that has been detected and/or confirmed; and potential anomalies refer to behavior that has been deemed to probably or possibly exist or have occurred. Detecting anomalies is now described in further detail with reference, for purposes of illustration, to the models 700 of FIG. 7 and 900 of FIG. 9.

Anomalies can be represented as nodes in a model in the form of anomalous nodes. For example, the nodes in FIG. 7 can represent variables such as those shown in the dependency diagram of FIG. 6, at least some of which are anomalies and/or can have an anomalous state (e.g., variable “Refrigerant level too low” is anomalous if its value is equal to “true”). More specifically, the nodes in FIG. 7 can represent “Temp of air to IT too high” (730-1), “Compressor running inefficiently” (730-2), “Refrigerant level low” (730-3), “One or more fans failed” (730-4), “Remaining fans running too fast” (730-5), “Air temp leaving evap. too high” (730-6), “RH of air leaving evap. too low” (730-7), “Air pressure at evap. exit too high” (730-8), “Condenser HX failed” (730-9), “Refrigerant temperature leaving condenser too high” (730-10), and “Refrigerant pressure leaving condenser too high” (730-11). It should be understood that the nodes can also represent broader and/or higher level states or anomalies, such as states of a whole EDC.

At step 1154, anomalies are detected based on, among other things, the model outputs which include or indicate the probable values of nodes, including anomalous nodes, given a known data (e.g., . . . , data_t−1, data_t, etc.). The known data can be data from an immediately preceding time instance such as time t−1. However, it should be understood that, by virtue of the function of the dynamic Bayesian network, the data from the immediately preceding time t−1 can incorporate outputs and data from time instances before time t−1. Determining anomalies or potentially anomalies at step 1154 therefore includes identifying nodes having probability values that are equal to 100% or within a certain threshold (e.g., within 0.1%, 0.5%, 1%, 2%, 5%, 10%, etc.) that indicates a sufficiently high probability of the occurrence or existence of an anomaly. Thus, with reference to FIG. 7, the values of nodes 730-1 to 730-11 can be analyzed to determine if their calculated probabilities signal the existence of an actual or potential anomaly.

In turn, if anomalies (potential or actual) are not detected at step 1154, the process iterates at the next time instance, starting at step 1150 with t+1 being assigned as the new time t. This indicates that the architecture and individual systems therein are operating normally and/or without anomalous behavior. On the other hand, if at step 1154, one or more anomalies or potential anomalies are detected, the anomalies are diagnosed at step 1156 and corrective measures are taken at step 1158.

That is, at step 1156, diagnosing the detected anomaly can include pinpointing the one or more causes of that failure. To do so, the model can be traversed starting from the anomaly node and identifying each path extending away from the anomaly node. For instance, with reference to FIG. 7, if the node 730-1 is identified as the anomaly node, the two paths that lead to nodes 730-6 and 730-3 can be identified and each of the nodes in those paths further analyzed. For example, in some embodiments, the likelihood of the value of the anomaly node 730-1 given the first path (730-2, 730-4, 730-5, 730-6) can be calculated, as well as the likelihood of the value of the anomaly ode 730-1 given the second path (730-2, 730-3). The aggregate likelihood of each of the paths can therefore indicate which path most likely led to the anomaly of node 730-1. Notably, the nodes in the first and second paths may have not had any anomalous behaviors associated therewith, such that anomalies of those nodes were not previously identified. Moreover, the likelihood of each of the nodes in the selected path can also be analyzed to determine which of those nodes had the highest likelihood of causing the value of the anomaly node. In this way, corrective actions can be better tailored to address issues impacting the selected path and node with highest likelihoods of having caused the anomaly.

In some embodiments, the diagnosing of step 1156 can also include identifying which nodes for which anomalies have not yet been detected are likely to fail. Predicting future failures can be based on the model outputs that indicate the probability of each state of each node. For instance, if a value is not yet beyond a probability threshold that triggers the existence of an anomaly, that node can be further analyzed to determine the likelihood of a failure (e.g., high probability) at a subsequent time period after t given the known data. Moreover, based on the identification of the most probably path that caused the failure, as described above, the path can be further be analyzed and leveraged to determine the next node likely to fail within that path.

In turn, at step 1158, one or more corrective actions can be performed to remedy or attempt to remedy the identified anomaly and/or causes of the anomaly. It should be understood that many corrective measures known to those of skill in the art can be triggered, based on the information identified in the diagnosis of step 1156. For purposes of illustration, examples includes migrating a workload to another datacenter, turning on additional cooling resources, rebooting, and/or transmitting notifications to other computing systems or devices. It should be understood that the corrective actions can be performed not merely to address existing anomalies but also to address issues based on predicted anomalies or anomalous behavior. In turn, the management, monitoring and maintenance process iterates at a next time instance starting at step 1150.

It should be understood that the detecting, remedying, and attempting to correct anomalies can be performed for individual systems (e.g., EACs) as well as a collection of systems (e.g., the architecture of FIG. 1). Thus, the states or observations of one EDC can trigger anomalies in another EDO, which in turn causes, for example, migrating to yet another EDC.

It should also be understood that, in some embodiments, the models described herein can be deployed on-demand, in addition to or alternative to their deployment as part of a continuous management, maintenance of monitoring process.

1. A system comprising:
one or more processors, and
at least one memory communicatively coupled to the processors, the at least one memory storing machine readable instructions that, when executed by the one or more processors cause the one or more processors to:
build a probabilistic model of a computing architecture comprising a plurality of computing devices, the building of the model comprising:
collecting first data corresponding to the plurality of computing devices;
generating the model structure of the probabilistic model based on the first data;
estimating the model parameters of the probabilistic model; and
storing the probabilistic model in the at least one memory.

2. The system of claim 1, wherein the probabilistic model represents the plurality of computing devices individually and collectively.

3. The system of claim 2, wherein
the computing devices include at least one or more edge data centers (EDCs), and
each of the computing devices include a plurality of sensors configured to obtain and transmit observed data.

4. The system of claim 3, wherein the first data includes one or more of:
graphical representations defining the relationships and dependencies within and among the computing devices; and
historical data of the computing architecture, comprising records including values of attributes associated with the computing devices, each of the records corresponding to a time instance, wherein the attributes are observation-type attributes or state-type attributes.

5. The system of claim 4, wherein the machine readable instructions, when executed by the one or more processors, further cause the one or more processors to:
generate a plurality of parameter sets, each of the parameter sets starting with the second parameter set being based on a preceding one of the plurality of parameter sets;
generate a plurality of observation sets from the historical data, each of the observation sets being a subset of the historical data;
for each of the parameter sets, calculate a probability of each observation set given the parameter set;
calculate a likelihood of the parameter set given the aggregate of the probabilities of all of the observation sets;
setting, as the model parameters, the parameter set resulting in the highest likelihood.

6. The system of claim 4, wherein:
the probabilistic model is defined by the model structure and the model parameters, and
wherein the probabilistic model comprises a plurality of nodes and edges, each of the nodes representing a variable associated with the computing architecture or computing devices thereof, and each of the edges representing a relationships between nodes.

7. The system of claim 6,
wherein at least two of the nodes of different computing devices are related, and at least two of the nodes are associated across different time instances of a time period.

8. The system of claim 6, wherein the machine readable instructions, when executed by the one or more processors, further cause the one or more processors to:
collect input data;
deploy the probabilistic model using the input data as inputs; and
execute one or more corrective actions based on the model outputs

9. The system of claim 6,
wherein the input data includes data associated with a current time instance and data associated with at least one previous time instance prior to the current time instance.

10. The system of claim 9, wherein
each of the nodes is configured to have one of a plurality of possible values,
the value of at least one of the nodes of the probabilistic model is unknown at the current time instance, and
the deploying the probabilistic model includes determining the probability of each possible value of each of the nodes, including the probability of each of the possible values of the at least one node having the unknown value at the current time.

11. The system of claim 10, wherein the executing the one or more corrective actions includes identifying one or more nodes having an actual or probable anomalous state at the current time.

12. A computer-implemented method comprising:
building a probabilistic model of a computing architecture comprising a plurality of computing devices, the building of the model comprising:
collecting first data corresponding to the plurality of computing devices;
generating the model structure of the probabilistic model based on the first data;
estimating the model parameters of the probabilistic model; and
storing the probabilistic model in a memory.

13. The computer-implemented method of claim 12, wherein the probabilistic model represents the plurality of computing devices individually and collectively.

14. The computer-implemented method of claim 13, wherein
the computing devices include at least one or more edge data centers (EDCs), and
each of the computing devices include a plurality of sensors configured to obtain and transmit observed data.

15. The computer-implemented method of claim 14, wherein the first data includes one or more of:
graphical representations defining the relationships and dependencies within and among the computing devices; and
historical data of the computing architecture, comprising records including values of attributes associated with the computing devices, each of the records corresponding to a time instance, wherein the attributes have are observation-type attributes or state-type attributes.

16. The computer-implemented method of claim 15, further comprising:
generate a plurality of parameter sets, each of the parameter sets starting with the second parameter set being based on a preceding one of the plurality of parameter sets;
generate a plurality of observation sets from the historical data, each of the observation sets being a subset of the historical data;
for each of the parameter sets, calculate a probability of each observation set given the parameter set;
calculate a likelihood of the parameter set given the aggregate of the probabilities of all of the observation sets;
setting, as the model parameters, the parameter set resulting in the highest likelihood.

17. The computer-implemented method of claim 15, wherein:
the probabilistic model is defined by the model structure and the model parameters, and
the wherein the probabilistic model comprises a plurality of nodes and edges, each of the nodes representing a variable associated with the computing architecture or computing devices thereof, and each of the edges representing a relationship between nodes.

18. The computer-implemented method of claim 17,
wherein at least two of the nodes of different computing devices are related, and at least two of the nodes are associated across different time instances of a time period.

19. The computer-implemented method of claim 17, further comprising:
collecting input data;
deploying the probabilistic model using the input data as inputs; and
executing one or more corrective actions based on the model outputs

20. The computer-implemented method of claim 19, wherein:
each of the nodes is configured to have one of a plurality of possible values,
the value of at least one of the nodes of the probabilistic model is unknown at the current time instance,
the deploying the probabilistic model includes determining the probability of each possible value of each of the nodes, including the probability of each of the possible values of the at least one node having the unknown value at the current time, and
the executing the one or more corrective actions includes identifying one or more nodes having an actual or probable anomalous state at the current time.
